(19) United States
(12) Patent Application Publication
(10) Pub. No.: US 2024/0027886 A1
(43) Pub. Date: Jan. 25, 2024

(54) ILLUMINATION SYSTEM AND PROJECTION DEVICE

(71) Applicant: Coretronic Corporation, Hsin-Chu (TW)

(72) Inventors: Yu-Hsiang Deng, Hsin-Chu (TW); Shih-Chen Chiou, Hsin-Chu (TW)

(73) Assignee: Coretronic Corporation, Hsin-Chu (TW)

(21) Appl. No.: 18/353,113

(22) Filed: Jul. 17, 2023

(30) Foreign Application Priority Data
Jul. 19, 2022 (CN) 202210848548.6

(51) Int. Cl. G03B 21/20

(52) U.S. Cl. CPC G03B 21/204; G03B 21/208

(57) ABSTRACT

An illumination system includes a first light source module, a second light source module, a light combiner and a light homogenizing element. The light combiner is disposed on a transmission path of the first light beam and the second light beam. The first light beam enters the light combiner from the first surface and is transmitted to the second surface to emit light. The second light beam enters the light combiner from the third surface, is totally reflected on the first surface of the light combiner, and is transmitted to the second surface to emit light. The light spot of the first light beam on the light incident surface of the light homogenizing element overlaps with the light spot of the second light beam on the light incident surface of the light homogenizing element.

### CROSS-REFERENCE TO RELATED APPLICATION

This application claims the priority benefit of China application serial no. 202210848548.6, filed on Jul. 19, 2022. The entirety of the above-mentioned patent application is hereby incorporated by reference herein and made a part of this specification.

### BACKGROUND OF THE DISCLOSURE

### Field of the Disclosure

The disclosure relates to an optical system and an electronic device, and more particularly, to an illumination system and a projection device.

### Description of Related Art

A projection device is a display device for projecting a large-size image, and the technology applied to the projection device is constantly improving with the evolution and innovation of technology. The principle of forming an image by the projection device is to convert the illumination beam generated by the illumination system into an image beam through a light valve, and then the image beam passes through the projection lens and is projected onto a projection target (such as a screen or a wall) to form a projection frame.

The mainstream laser projectors include a combiner system, an illumination system, and a projection lens. The light sources in the combiner system are mainly categorized into three-color pure laser light sources, phosphor excitation light sources, and light-emitting diodes light sources. At present, the three-color pure laser light source generates laser speckle and has the problem that the brightness is limited by a package structure. In addition, since the wavelength band of the laser light emitted by the pure laser light source is similar to and partially overlapped with the wavelength band of the fluorescent light emitted by the phosphor excitation light source, in order to combine the laser light and the fluorescent light, the dichroic coating must have high transmittance (low reflectivity) for the wavelength band near a specific wavelength. As a result, fluorescence in some bands is compromised and brightness is also compromised.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE DISCLOSURE

The disclosure provides an illumination system and a projection device, which may increase the light-use efficiency of the illumination system and reduce the volume at the same time.

Other objects and advantages of the disclosure can be further understood from the technical features disclosed in the disclosure.

In order to achieve one or part or all of the above purposes or other purposes, the disclosure provides an illumination system including a first light source module, a second light source module, a light combiner and a light homogenizing element. The first light source module is configured to provide a first light beam. The second light source module is configured to provide the second light beam. The light combiner is disposed on a transmission path of the first light beam and the second light beam. The light combiner has a first surface, a second surface and a third surface. The first light beam from the first light source module enters the light combiner from the first surface and is transmitted to the second surface to emit light. The second light beam from the second light source module enters the light combiner from the third surface, is totally reflected on the first surface of the light combiner, and is transmitted to the second surface to emit light. The light homogenizing element is disposed on a transmission path of the first light beam and the second light beam from the light combiner. The light homogenizing element has a light incident surface, and the illumination beam includes at least one of the first light beam and the second light beam. The light spot of the first light beam on the light incident surface of the light homogenizing element overlaps with the light spot of the second light beam on the light incident surface of the light homogenizing element.

In order to achieve one or part or all of the above purpose or other purposes, the disclosure further provides a projection device, which includes an illumination system, at least one light valve and a projection lens. The illumination system is configured to provide illumination beams. The illumination system includes a first light source module, a second light source module, a light combiner and a light homogenizing element. The first light source module is configured to provide the first light beam. The second light source module is configured to provide the second light beam. The light combiner is disposed on a transmission path of the first light beam and the second light beam. The light combiner has a first surface, a second surface and a third surface. The first light beam from the first light source module enters the light combiner from the first surface and is transmitted to the second surface to emit light. The second light beam from the second light source module enters the light combiner from the third surface, is totally reflected on the first surface of the light combiner, and is transmitted to the second surface to emit light. The light homogenizing element is disposed on a transmission path of the first light beam and the second light beam from the light combiner. The light homogenizing element has a light incident surface, and the illumination beam includes at least one of the first light beam and the second light beam, and the light spot of the first light beam on the light incident surface of the light homogenizing element overlaps with the light spot of the second light beam on the light incident surface of the light homogenizing element. The at least one light valve is disposed on a transmission path of the illumination beam and is configured to convert the illumination beam into an image beam. The projection lens is disposed on a transmission path of the image beam, and is configured to project the image beam out of the projection device.

Based on the above, the embodiments of the disclosure have at least one of the following advantages or effects. In the illumination system and the projection device of the disclosure, the illumination system includes a first light source module, a second light source module, a light combiner, and a light homogenizing element. The first light beam from the first light source module enters the light combiner from the first surface and is transmitted to the second surface of the light combiner to emit light. The second light beam from the second light source module enters the light combiner from the third surface, is totally reflected on the first surface, and transmitted to the second surface to emit light. Further, the light spot of the first light beam on the light incident surface of the light homogenizing element overlaps with the light spot of the second light beam on the light incident surface of the light homogenizing element. In addition, the wavelength range of the first light beam from the first light source module is at least partially overlapped with the wavelength range of the second light beam from the second light source module. In this way, two light beams with partially overlapping wavelength bands may be combined through the light-combining function of the light combiner. Compared with the conventional method of using dichroic coatings, the light-use efficiency of the illumination system of the disclosure may be enhanced, and the volume may be reduced at the same time.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projection device according to an embodiment of the disclosure.

FIG. 2 is a schematic view of a portion of an illumination system according to an embodiment of the disclosure.

FIG. 3 is a schematic view of a portion of an illumination system according to another embodiment of the disclosure.

FIG. 4 is a schematic view of a portion of an illumination system according to still another embodiment of the disclosure.

### DESCRIPTION OF EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

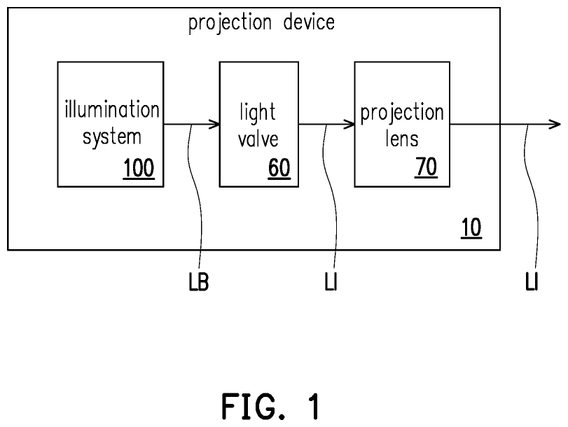

FIG. 1 is a schematic view of a projection device according to an embodiment of the disclosure. Please refer to FIG. 1. This embodiment provides a projection device including an illumination system 100, at least one light valve 60 and a projection lens The illumination system 100 is configured to provide an illumination beam LB. The at least one light valve 60 is disposed on a transmission path of the illumination beam LB and is configured to convert the illumination beam LB into the image beam LI. The projection lens 70 is disposed on a transmission path of the image beam LI, and is configured to project the image beam LI out of the projection device 10 onto a projection target (not shown), such as a screen or a wall.

The illumination system 100 is configured to provide an illumination beam LB. For instance, in this embodiment, the illumination system 100 is composed of, for example, a plurality of light-emitting elements, a wavelength conversion element, a light homogenizing element, a filter element, and a plurality of light splitting and combining elements, so as to provide light having different wavelengths to form the illumination beam LB. The detailed structure and implementation of the illumination system 100 can be derived from ordinary knowledge in the technical field with sufficient teaching, suggestion and implementation.

In the embodiment, the light valve 60 is, for example, a reflective light modulator such as a Liquid Crystal On Silicon panel (LCoS panel), a Digital Micro-mirror Device (DMD), and so on. In some embodiments, the light valve 60 may also be a transmissive light modulator such as a Transparent Liquid Crystal Panel, an Electro-Optical Modulator, a Magneto-Optic modulator, or an Acousto-Optic Modulator (AOM). The disclosure provides no limitation to the type and form of the light valve 60. The detailed steps and implementation of the method for the light valve 60 to convert the illumination beam LB into the image beam LI may be obtained from the common knowledge in the technical field with sufficient teaching, suggestion and implementation, and therefore no further description is incorporated herein. In this embodiment, the number of light valves 60 is one, for example, the projection device 10 using one single DMD, but in other embodiments, there may be multiple light valves 60, and the disclosure is not limited thereto.

The projection lens 70 includes, for example, one or a combination of multiple optical lenses with refractive power, such as various combinations of non-planar lenses including biconcave lenses, biconvex lenses, concave-convex lenses, convex-concave lenses, plane-convex lenses, plane-concave lenses, etc. In an embodiment, the projection lens 70 may further include a planar optical lens to project the image beam LI from the optical valve 60 to the projection target in a reflective manner. The disclosure does not limit the form and type of the projector lens 70.

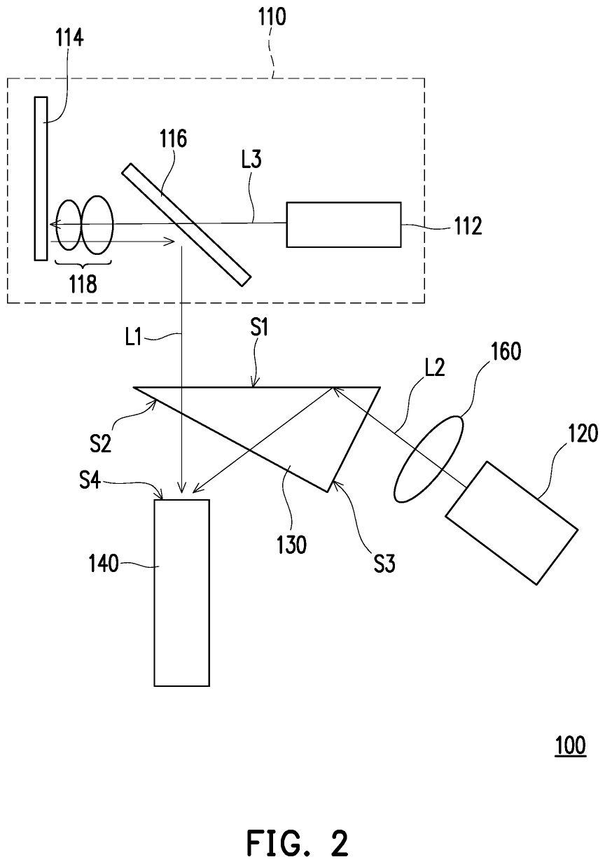

FIG. 2 is a schematic view of a portion of an illumination system according to an embodiment of the disclosure. Please refer to FIG. 2. This embodiment provides an illumination system 100, which at least may be applied to the projection device 10 of FIG. 1. The illumination system 100 includes a first light source module 110, a second light source module 120, a light combiner 130 and a light homogenizing element 140. The first light source module 110 is configured to provide the first light beam L1, and the second light source module 120 is configured to provide the second light beam L2. The wavelength range of the first light beam L1 at least partially overlaps with the wavelength range of the second light beam L2.

In detail, the first light source module 110 is one of a laser diode module, an excitation phosphor module, and a light-emitting diode module, and the second light source module 120 is the other one of the laser diode module, the excitation phosphor module, and the light-emitting diode module. The first light source module 110 and the second light source module 120 are different light source modules. For example, in this embodiment, the first light source module 110 is an excitation phosphor module, and the first light source module 110 includes a laser light-emitting element 112 and a wavelength conversion element 114. The number of the laser light-emitting elements 112 may be one or more to provide an excitation beam L3, which is transmitted to the wavelength conversion element 114 and converted into the first light beam L1, and the wavelength of the first light beam L1 is different from that of the excitation light beam L3. The laser light-emitting element 112 is, for example, a blue laser diode or a blue light-emitting diode. The wavelength conversion element 114 is, for example, a phosphor wheel, which may convert the blue excitation beam L3 into the yellow-green first light beam L1. In this embodiment, the excitation phosphor module (the first light source module 110) further includes a dichroic element 116, such as a dichroic mirror, configured to adjust an optical path so that the excitation beam L3 is transmitted to pass through the wavelength conversion element 114, and reflects the first light beam L1 to the light combiner 130. In this embodiment, the dichroic element 116 is, for example, a dichroic mirror that allows blue light to pass through and reflects yellow-green light. In addition, at least one converging element 118 may be additionally disposed between the wavelength conversion element 114 and the dichroic element 116, and the disclosure is not limited thereto.

If the first light source module 110 is an excitation phosphor module, the second light source module 120 may be one of a laser diode module or a light-emitting diode module. In this embodiment, the second light source module 120 is, for example, a laser diode module, and the laser diode module may be a green laser diode, a red laser diode, or a green and red laser diode module, configured to provide green or/and red second light beam L2. In other embodiments, the second light source module 120 may also be a light-emitting diode module, and the light-emitting diode module may be a green light-emitting diode, a red light-emitting diode, or a green and red light-emitting diode module, configured to provide green or/and red second light beam L2. However, in different embodiments, the types of the first light source module 110 and the second light source module 120 may also be switched, and the disclosure is not limited thereto. In different embodiments, if the second light source module 120 is a laser diode module, the second light source module 120 may include green, red and blue laser diodes, or if the second light source module 120 is a light-emitting diode module, the second light source module 120 may include green, red and blue light-emitting diodes. Based on different types of light source configurations, the illumination system 100 may further include a converging element 160 disposed between the second light source module 120 and the light combiner 130, and configured to converge the second light beam L2, but the disclosure is not limited thereto. In other embodiments, a converging element may also be disposed between the first light source module 110 and the light combiner 130 for converging the first light beam L1.

The light combiner 130 is disposed on a transmission path of the first light beam L1 and the second light beam L2. The light combiner 130 has a first surface S1, a second surface S2, and a third surface S3. The first light beam L1 from the first light source module 110 enters the light combiner 130 from the first surface S1 and is transmitted inside the light combiner 130 to the second surface S2 to emit light, while the second light beam L2 from the second light source module 120 enters the light combiner 130 from the third surface S3, is totally reflected on the first surface S1 of the light combiner 130, and is transmitted to the second surface S2 to emit light. For example, in this embodiment, the light combiner is, for example, a total internal reflection prism (TIR prism), and the first surface S1, the second surface S2, and the third surface S3 thereof have no optical coating or only have an anti-reflection coating. In an embodiment, the converging element 160 may also be directly formed on the first surface S1, so that the second light beam L2 may be adopted alone or the first light beam L1 and the second light beam L2 may be adopted together.

The light homogenizing element 140 is disposed on a transmission path of the first light beam L1 and the second light beam L2 from the light combiner 130, and is configured to receive the first light beam L1 and/or the second light beam L2 to provide the illumination beam LB, that is, the illumination beam LB includes at least one of the first light beam L1 and the second light beam L2. The light homogenizing element 140 adjusts the shape of light spot of the illumination beam LB, so that the shape of light spot of the illumination beam LB may match the shape (for example, a rectangle) of the working region of the light valve 60, and the light intensity is the same or similar throughout the light spot, thereby homogenizing the light intensity of the illumination beam LB. In this embodiment, the light homogenizing element 140 is, for example, an integrating cylinder, but in other embodiments, the light homogenizing element 140 may also be an optical element of other suitable types, such as a lens array (fly eye lens array), and the disclosure is not limited thereto. The light homogenizing element 140 has a light incident surface S4, and the light spot of the first light beam L1 on the light incident surface S4 of the light homogenizing element 140 overlaps with the light spot of the second light beam L2 on the light incident surface S4 of the light homogenizing element 140. In this way, two light beams with partially overlapping wavelength bands may be combined through the light combining function of the light combiner 130. Compared with the conventional method of using dichroic coatings, the light-use efficiency of the illumination system 100 of the disclosure may be enhanced, and the volume may be reduced at the same time. With the configuration of the light combiner 130, the first light beam L1 and the second light beam L2 from two light source modules respectively are incident to the light homogenizing element 140 at similar angles, thereby improving the light uniformity. In addition, by combining light from two different types of light sources, the laser speckle generated by the laser light source may further be reduced.

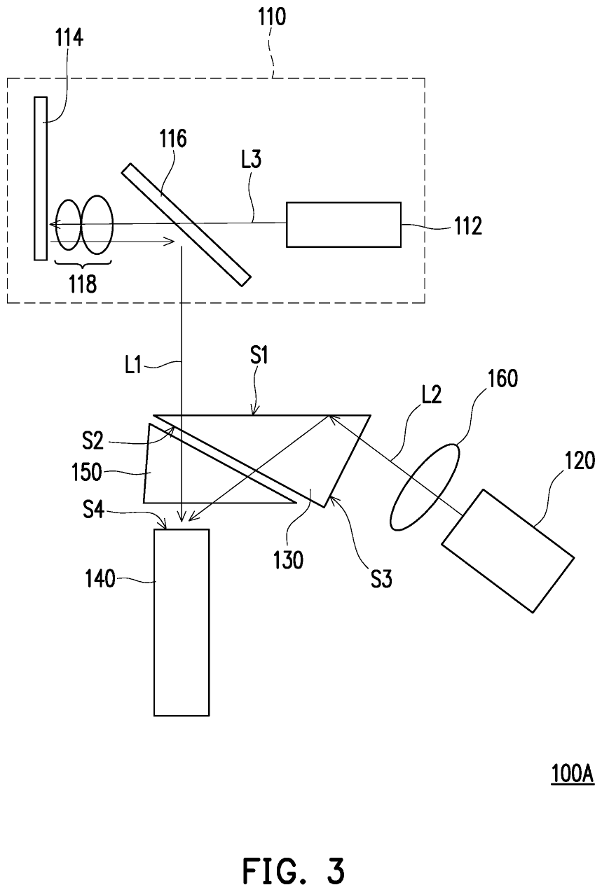

FIG. 3 is a schematic view of a portion of an illumination system according to another embodiment of the disclosure. Please refer to FIG. 3. The illumination system 100A of the embodiment is similar to the illumination system 100 shown in FIG. 2. The difference between the two is that, in this embodiment, the illumination system 100A further includes an optical path compensation element 150, which is disposed between the first light source module 110 and the light combiner 130 or between the light combiner 130 and the light homogenizing element 140. The optical path compensation element 150 is, for example, a light-transmitting element, and the refractive index of the light combiner 130 is greater than or equal to the refractive index of the optical path compensation element 150. The optical path compensation element 150 and the light combiner 130 are spaced apart, so as to perform optical path compensation on the light beams passing through. In the embodiment of FIG. 3, the optical path compensation element 150 is disposed between the light combiner 130 and the light homogenizing element 140, and the second surface S2 of the light combiner 130 is parallel with a surface of the optical path compensation element 150 facing the light combiner 130. The first light beam L1 from the first light source module 110 enters the light combiner 130 from the first surface S1 and is transmitted inside the light combiner 130 to the second surface S2 to emit light, subsequently enters the optical path compensation element 150 from a surface of the optical path compensation element 150 facing the light combiner 130, and exits the optical path compensation element 150 from a surface of the optical path compensation element 150 facing the light homogenizing element 140. The second light beam L2 from the second light source module 120 enters the light combiner 130 from the third surface S3 and is totally reflected on the first surface S1 of the light combiner 130 to be transmitted to the second surface S2 to emit light, subsequently enters the optical path compensation element 150 from a surface of the optical path compensation element 150 facing the light combiner 130, and exits the optical path compensation element 150 from a surface of the optical path compensation element 150 facing the light homogenizing element 140. The optical-path-length of the first light beam L1 in the optical path compensation element 150 is greater than the optical-path-length of the second light beam L2 in the optical path compensation element 150. In this way, the light-use efficiency of the light entering the light homogenizing element 140 may be further improved.

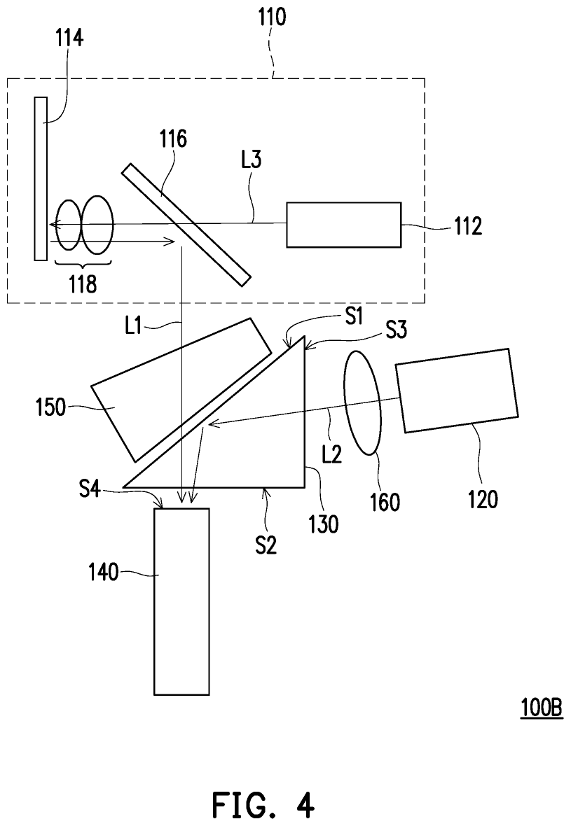

FIG. 4 is a schematic view of a portion of an illumination system according to still another embodiment of the disclosure. Please refer to FIG. 4. The illumination system 100B of this embodiment is similar to the illumination system 100A of FIG. 3. The difference between the two is that, in this embodiment, the optical path compensation element 150 is disposed between the first light source module 110 and the light combiner 130. The first surface S1 of the light combiner 130 is arranged in parallel with a surface of the optical path compensation element 150 facing the light combiner 130. The first light beam L1 enters the optical path compensation element 150 from a surface of the optical path compensation element 150 facing the first light source module 110, and exits the optical path compensation element 150 from the surface of the optical path compensation element 150 facing the light combiner 130, subsequently enters the light combiner 130 from the surface S1 and is transmitted inside the light combiner 130 to the second surface S2 to emit light. The second light beam L2 from the second light source module 120 enters the light combiner 130 from the third surface S3, is totally reflected on the first surface S1 of the light combiner 130, and is transmitted to the second surface S2 to emit light. The optical path compensation element 150 is not located on the transmission path of the second light beam L2, so the second light beam L2 directly enters the light homogenizing element 140 after being totally reflected in the light combiner 130 without passing through the optical path compensation element 150. In this way, the light-use efficiency of the light entering the light homogenizing element 140 may be further improved.

To sum up, in the illumination system and the projection device of the disclosure, the illumination system includes a first light source module, a second light source module, a light combiner, and a light homogenizing element. The first light beam from the first light source module enters the light combiner from the first surface and is transmitted to the second surface of the light combiner to emit light. The second light beam from the second light source module enters the light combiner from the third surface, is totally reflected on the first surface, and transmitted to the second surface to emit light. Further, the light spot of the first light beam on the light incident surface of the light homogenizing element overlaps with the light spot of the second light beam on the light incident surface of the light homogenizing element. In addition, the wavelength range of the first light beam from the first light source module is at least partially overlapped with the wavelength range of the second light beam from the second light source module. In this way, two light beams with partially overlapping wavelength bands may be combined through the light-combining function of the light combiner. Compared with the conventional method of using dichroic coatings, the light-use efficiency of the illumination system of the disclosure may be enhanced, and the volume may be reduced at the same time.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An illumination system, comprising a first light source module, a second light source module, a light combiner and a light homogenizing element, wherein
the first light source module is configured to provide a first light beam;
the second light source module is configured to provide a second light beam;
the light combiner is disposed on a transmission path of the first light beam and the second light beam, wherein the light combiner has a first surface, a second surface and a third surface, the first light beam from the first light source module enters the light combiner from the first surface and is transmitted to the second surface to emit light, the second light beam from the second light source module enters the light combiner from the third surface, is totally reflected on the first surface of the light combiner, and is transmitted to the second surface to emit the light; and
the light homogenizing element is disposed on the transmission path of the first light beam and the second light beam from the light combiner, the light homogenizing element has a light incident surface, wherein an illumination beam comprises at least one of the first light beam and the second light beam, and a light spot of the first light beam on the light incident surface of the light homogenizing element overlaps with a light spot of the second light beam on the light incident surface of the light homogenizing element.

2. The illumination system according to claim 1, wherein the first light source module is different from the second light source module, and the first light source module is one of a laser diode module, an excitation phosphor module, and a light-emitting diode module, and the second light source module is the other of the laser diode module, the excitation phosphor module, and the light-emitting diode module.

3. The illumination system according to claim 2, wherein the excitation phosphor module comprises a laser light-emitting element and a wavelength conversion element, the laser light-emitting element is configured to provide an excitation beam, and the excitation beam is transmitted to the wavelength conversion element to be converted into the first light beam or the second light beam.

4. The illumination system according to claim 1, wherein the light combiner comprises an anti-reflection coating formed on the first surface, the second surface and the third surface.

5. The illumination system according to claim 1, further comprising an optical path compensation element, which is disposed between the first light source module and the light combiner or between the light combiner and the light homogenizing element.

6. The illumination system according to claim 5, wherein a refractive index of the light combiner is greater than a refractive index of the optical path compensation element.

7. The illumination system according to claim 5, wherein the optical path compensation element and the light combiner are spaced apart.

8. The illumination system according to claim 5, wherein when the optical path compensation element is disposed between the light combiner and the light homogenizing element, an optical-path-length of the first light beam in the optical path compensation element is greater than an optical-path-length of the second light beam in the optical path compensation element.

9. The illumination system according to claim 5, wherein when the optical path compensation element is disposed between the first light source module and the light combiner, the optical path compensation element is not located on a transmission path of the second light beam.

10. The illumination system according to claim 1, further comprising a converging element, disposed between the first light source module and the light combiner or between the second light source module and the light combiner.

11. A projection device, comprising an illumination system, at least one light valve and a projection lens, wherein
the illumination system is configured to provide an illumination beam, and comprises a first light source module, a second light source module, a light combiner and a light homogenizing element, wherein
the first light source module is configured to provide a first light beam;
the second light source module is configured to provide a second light beam;
the light combiner is disposed on a transmission path of the first light beam and the second light beam, wherein the light combiner has a first surface, a second surface and a third surface, the first light beam from the first light source module enters the light combiner from the first surface and is transmitted to the second surface to emit light, the second light beam from the second light source module enters the light combiner from the third surface, is totally reflected on the first surface of the light combiner, and is transmitted to the second surface to emit the light; and
the light homogenizing element is disposed on the transmission path of the first light beam and the second light beam from the light combiner, the light homogenizing element has a light incident surface, wherein an illumination beam comprises at least one of the first light beam and the second light beam, and a light spot of the first light beam on the light incident surface of the light homogenizing element overlaps with a light spot of the second light beam on the light incident surface of the light homogenizing element;
wherein the at least one light valve is disposed on a transmission path of the illumination beam and is configured to convert the illumination beam into an image beam; and
the projection lens is disposed on a transmission path of the image beam, and is configured to project the image beam out of the projection device.

12. The projection device according to claim 11, wherein the first light source module is different from the second light source module, and the first light source module is one of a laser diode module, an excitation phosphor module, and a light-emitting diode module, and the second light source module is the other of the laser diode module, the excitation phosphor module, and the light-emitting diode module.

13. The projection device according to claim 12, wherein the excitation phosphor module comprises a laser light-emitting element and a wavelength conversion element, the laser light-emitting element is configured to provide an excitation beam, and the excitation beam is transmitted to the wavelength conversion element to be converted into the first light beam or the second light beam.

14. The projection device according to claim 11, wherein the light combiner comprises an anti-reflection coating formed on the first surface, the second surface and the third surface.

15. The projection device according to claim 11, wherein the illumination system further comprises an optical path compensation element, which is disposed between the first light source module and the light combiner or between the light combiner and the light homogenizing element.

16. The projection device according to claim 15, wherein a refractive index of the light combiner is greater than a refractive index of the optical path compensation element.

17. The projection device according to claim 15, wherein the optical path compensation element and the light combiner are spaced apart.

18. The projection device according to claim 15, wherein when the optical path compensation element is disposed between the light combiner and the light homogenizing element, an optical-path-length of the first light beam in the optical path compensation element is greater than an optical-path-length of the second light beam in the optical path compensation element.

19. The projection device according to claim 15, wherein when the optical path compensation element is disposed between the first light source module and the light combiner, the optical path compensation element is not located on a transmission path of the second light beam.

20. The projection device according to claim 11, wherein the illumination system further comprises a converging element, disposed between the first light source module and the light combiner or between the second light source module and the light combiner.
